(19) United States
(12) Patent Application Publication
(10) Pub. No.: US 2004/0024843 A1
(43) Pub. Date: Feb. 5, 2004

(54) Method for provisioning distributed web applications

(76) Inventor: Christopher T. Smith, Aloha, OR (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/209,818

(22) Filed: Jul. 31, 2002

(51) Int. Cl. G06F 15/16

(52) U.S. Cl. 709/219; 345/749

(57) ABSTRACT

A method and apparatus for provisioning distributed web applications includes a server receiving an identifier corresponding to a first user interface (UI) object to be displayed within a client browser, the server generating one or more client-side scripts designed to facilitate generation of a hierarchical client based object model, the hierarchical object model including a root object, a context object to store state information corresponding to at least one of the root object and one or more child objects, and a window manager to facilitate control of one or more display properties of at least one secondary UI window, the server delivering content and the one or more client-side scripts to the client, and the client generating hierarchical client based object model in response to the execution of the one or more client-side scripts.

### BACKGROUND OF THE INVENTION

1. Field of the Invention

The invention generally relates to data communications. More specifically, the invention relates to a method and apparatus for provisioning distributed web applications.

2. Background Information

With advances in integrated circuit, microprocessor, networking and communication technologies, an increasing number of devices, in particular digital computing devices, are being networked together. At the same time, an ever-increasing number of software application providers and users are turning to the Internet, or more specifically, to the World Wide Web for delivery of software services. Such web delivery of software services has come to be referred to as web services, where application-programming logic is assembled and delivered to a wide variety of users and client platforms via one or more open web-based protocols such as the hypertext transfer protocol (HTTP), SOAP, XML, and so forth.

Although web based application services provide near ubiquitous access to software services by a large number of users, the user experience nonetheless remains limited compared to that of a traditional (i.e., non-web based/locally executing) applications. Firstly, current web based application delivery solutions require constant interaction between the client device and the server providing the programming logic and/or content to the client device. For example, if a user opts to navigate from one page of content to another, user input indicating the corresponding page selection is typically communicated to a web server, which then returns updated content and/or programming logic based upon the user input. In the case of content, multiple frames displayed within the client browser may each require updated information from the server causing numerous connections to be made between the client and the server. Such continuous communication between the client and the server can cause indeterminate delays depending e.g. upon the status of the network connection or the processing load borne by the one or more servers responsible for providing content. Secondly, traditional applications typically provide a graphical user interface utilizing multiple display windows to facilitate user interaction with the application. In prior art web-based applications, however, such a multi-window user interaction is not available. More specifically, as part of the application interaction, the user is typically forced to navigate across various web pages (including graphical dialogs, forms, and so forth) through a single browser window. Although some web applications and/or pages may cause additional browser windows to be opened in response to user input, each of the opened windows act autonomously with respect to one another, thus yielding a seemingly disjointed user experience.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates an overview of the present invention in accordance with one embodiment;

FIG. 2 illustrates an architectural block diagram of server 130, in accordance with one embodiment of the invention;

FIG. 3 illustrates UI component architecture 238 as a canonical model of hierarchically arranged UI components for provisioning a web application to a single or multiple clients, in accordance with one embodiment of the invention;

FIGS. 4a-b illustrate example code for obtaining and outputting a UI component as well as corresponding child components for display by a client;

FIG. 5 illustrates an example graphical user interface showing the console UI component of FIG. 3 displayed in association with corresponding child components, in accordance with one embodiment;

FIG. 6 illustrates an example operational flow for server 130, in accordance with one embodiment of the invention;

FIG. 7 illustrates an example client computing environment including a client-side object model generated in accordance with one embodiment of the invention;

FIG. 8 illustrates an example operational flow of the window manager, in accordance with one embodiment of the invention;

FIG. 9 illustrates a client-server operational flow in accordance with one embodiment of the invention; and

FIG. 10 illustrates an example computer system suitable for use in association with the present invention, in accordance with one embodiment.

### DETAILED DESCRIPTION OF THE INVENTION

In the following description, various aspects of the present invention will be described. However, it will be apparent to those skilled in the art that the present invention may be practiced with only some or all aspects of the present invention. For purposes of explanation, specific configurations are set forth in order to provide a thorough understanding of the present invention. However, it will also be apparent to one skilled in the art that the present invention may be practiced without the specific details. In other instances, well-known features are omitted or simplified in order not to obscure the present invention.

Parts of the description will be presented in terms of operations performed by a processor based device, using terms such as data, receiving, identifying, storing, selecting, determining, and the like, consistent with the manner commonly employed by those skilled in the art to convey the substance of their work to others skilled in the art. As well understood by those skilled in the art, the quantities take the form of electrical, magnetic, or optical signals capable of being stored, transferred, combined, and otherwise manipulated through mechanical and electrical components of the processor based device; and the term processor include microprocessors, micro-controllers, digital signal processors, and the like, that are standalone, adjunct or embedded.

Various operations will be described as multiple discrete steps in turn, in a manner that is most helpful in understanding the present invention, however, the order of description should not be construed as to imply that these operations are necessarily order dependent. In particular, these operations need not be performed in the order of presentation. Further, the description repeatedly uses the phrase “in one embodiment”, which ordinarily does not refer to the same embodiment, although it may.

Additionally, the terms “including”, “having” and “comprising” are used interchangeably herein (in both the detailed specification as well as the claims), and should not be interpreted as exclusionary terms. More specifically, unless otherwise stated, the terms “including”, “having” and “comprising” are intended to refer to at least those elements delineated in association with each term and not necessarily only those elements so delineated.

Overview

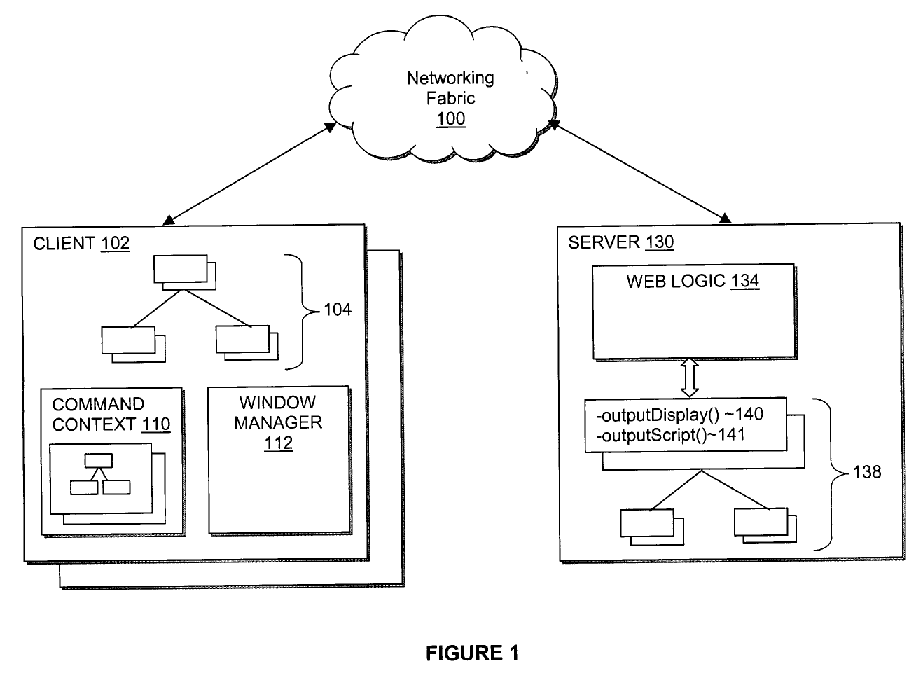

Reference is now drawn to FIG. 1, wherein a block diagram illustrating an overview of the distributed web application provisioning method and apparatus of the present invention, in accordance with one embodiment is shown. As illustrated, one or more clients (102) are communicatively coupled to server 130 via networking fabric 100. Networking fabric 100 represents one or more local and/or global networks such as, but not limited to the Internet, through which data can be exchanged between server 130 and client 102 in accordance with one or more data communication and/or telecommunication protocols.

In accordance with one embodiment of the invention, server 130 is endowed with web logic 134 and hierarchical Meta data 138 to cooperatively generate one or more content pages for display by client 102 and one or more client-side scripts for execution by client 102. In accordance with one embodiment of the invention, hierarchical Meta data 138 is implemented in an object-oriented manner, with each “node” of the hierarchy representing a user interface (UI) component automatically having a number of associated methods (pre-provided). In one embodiment, each UI component includes an outputDisplay method 140 to be invoked to contribute to the output of display content associated with the component, and an outputScript method 141 to be invoked to contribute to the output of one or more script(s) associated with the component.

Client 102 is equipped with an execution environment to display one or more content pages and execute one or more client-side scripts provided by server 130. In accordance with one embodiment of the invention, execution of one or more of the client-side scripts by client 102 causes the generation of localized object model 104 on client 102, complimented with command context 110 for providing localized state management, and window manager 112 for providing coordinated display of content within multiple browser windows. The provision of command context 110 enables state information to be stored locally on client 102, thereby removing the need to post intermediate state to server 130 and decreasing the chance of communication delays typically experienced by web application users. Moreover, the provision of window manager 112 enables centralized management and control of graphical window displays on the client via the executing web application. Thus, as will be described in more detail below, the present invention facilitates the manifestation of an enhanced web application user experience.

Server-Side Architecture

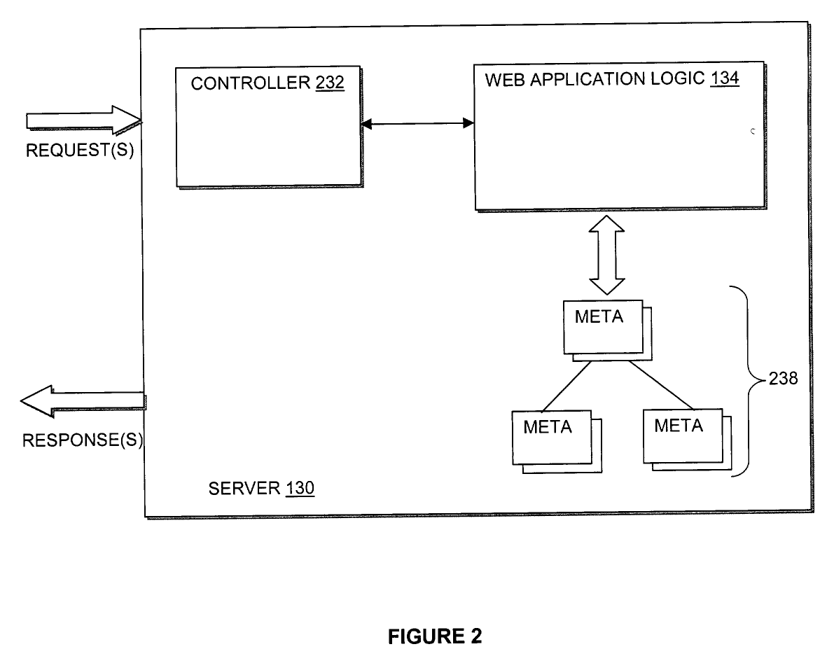

FIG. 2 illustrates an architectural block diagram of server 130, in accordance with one embodiment of the invention. Server 130 includes controller 232, web logic 134, and UI component architecture 238, which cooperatively function to dispatch web service components to client 102. In one embodiment, controller 232 is implemented as a single servlet that listens for client requests received e.g. on a designated communication port bound to one or more supported service bindings. For example, such service bindings may include (but are not limited to) generic HTTP, SOAP over HTTP, SOAP over SMTP, and so forth. In one embodiment, requests are received in the form of one or more URl's identifying one or more of UI components 238. For example, a request may include a URl such as “/console/con.showTool.cmd?toolid=ViolationManager”. Upon receiving a client request including an identifying URl, controller 232 identifies an appropriate command to be executed based upon the received request, executes the identified command accordingly, and returns any results to the browser as a response. In one embodiment, web logic 134 includes one or more Java Server Pages (JSPs) that are accessed by commands identified by controller 232 to provide UI component-based content pages to client 102. Similarly, in one embodiment, web logic 134 includes script generation facilities (not shown) to produce one or more client-side scripts based upon Meta-data corresponding to UI components 238 and identified by the one or more received URls.

In general, server 130 is intended to represent a broad range of devices equipped to communicate with one or more client devices as well as provide script generation and content delivery services of the present invention. Server 130 may represent one or a collection of desktop/laptop computing devices, appliances, blade servers, and so forth having one or more processors equipped to execute code to provide such functionality described herein with respect to server 130.

Server-Side UI Component Model

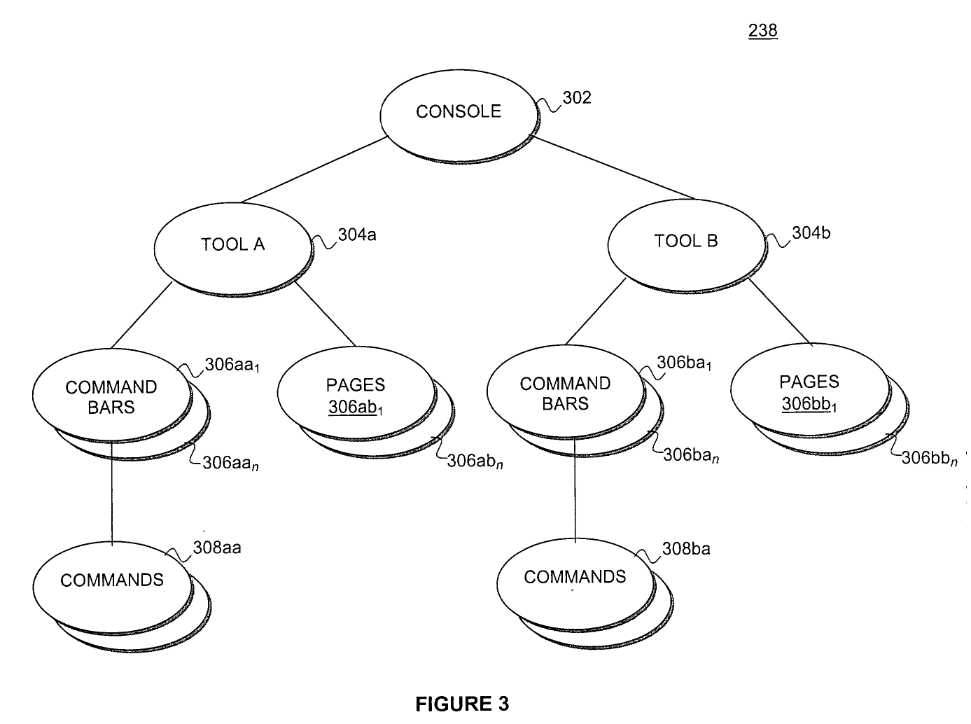

FIG. 3 illustrates UI component architecture 238 as a canonical model of hierarchically arranged UI components for provisioning a web application to a single or multiple clients, in accordance with one embodiment of the invention. As described above, UI component architecture 238 resides on server 130 and is comprised of independently addressable, hierarchical UI components 302-308 to constitute a web application user interface. As described herein, the component/object hierarchies contain at least one parent component/object (i.e. “node”) and possibly one or more children components/objects. A root component/object is one that does not have any parent components.

In one embodiment, each of UI components 302-308 include at least a first method (e.g. outputDisplay method 140) to contribute to the output of display content (e.g. HTML) associated with one or more of UI components 302-308, and a second method (e.g. outputScript method 141) to contribute to the output of one or more script(s) associated with UI components 302-308. In one embodiment, outputScript method 141 contributes to the output of one or more JavaScript based script(s).

In one embodiment, UI components 302-308 include Meta data manifestations of the UI components. As such, when invoked (e.g. by a client transmitting a request to the server indicating one or more URl's corresponding to a UI component), outputScript method 141 causes a script generator to generate one or more client-side scripts by processing the Meta data corresponding to at least the identified UI component. In one embodiment, the Meta data of the identified UI component in addition to the Meta data of all children UI components (of the accessed component) are processed in response to the client request. As will be described in further detail below, the client-side script(s), when executed, cause the generation of a localized client object model containing UI objects corresponding to those of UI components 302-308 whose Meta data was processed by the script generator. Accordingly, each client can directly access a different UI component based at least in part upon the needs of the user, and the corresponding content of the client request.

In the illustrated embodiment, UI component 302 represents a default web console component that provides the framework through which each of UI components 304-308 may be accessed. The UI components of FIG. 3 may represent a variety of user interface components including tools, property editors, property sheets, client commands, content pages, and so forth. For example, in the illustrated embodiment, UI components 304a-304b represent specific web application tools, whereas UI components 306aa and 306ba represent command bars associated with each of the corresponding tools. Furthermore, UI components 306ab and 306bb represent content pages corresponding to each respective tool, while UI components 308aa and 308ba represent command objects associated with each corresponding command bar object. It should be noted that additional UI components as well as fewer UI components than those displayed in FIG. 3 may alternatively be declared without departing from the spirit and scope of the invention.

Component Display

In one embodiment of the invention, the rendering of display output for a UI component is performed via a JSP. In such an embodiment, the UI component to be output is passed to the JSP as a request attribute, and the JSP then produces HTML (or other equivalent code) for the component and sends the result to the client. In one embodiment, the JSP further triggers child components of the requested component to output themselves as well. The requested component can be placed into one frame on the client, while the children of the requested component can be placed into one or more additional frames via a frameset. Alternatively, children components may be output within the current frame by e.g. invoking the outputDisplay( ) method on the child component.

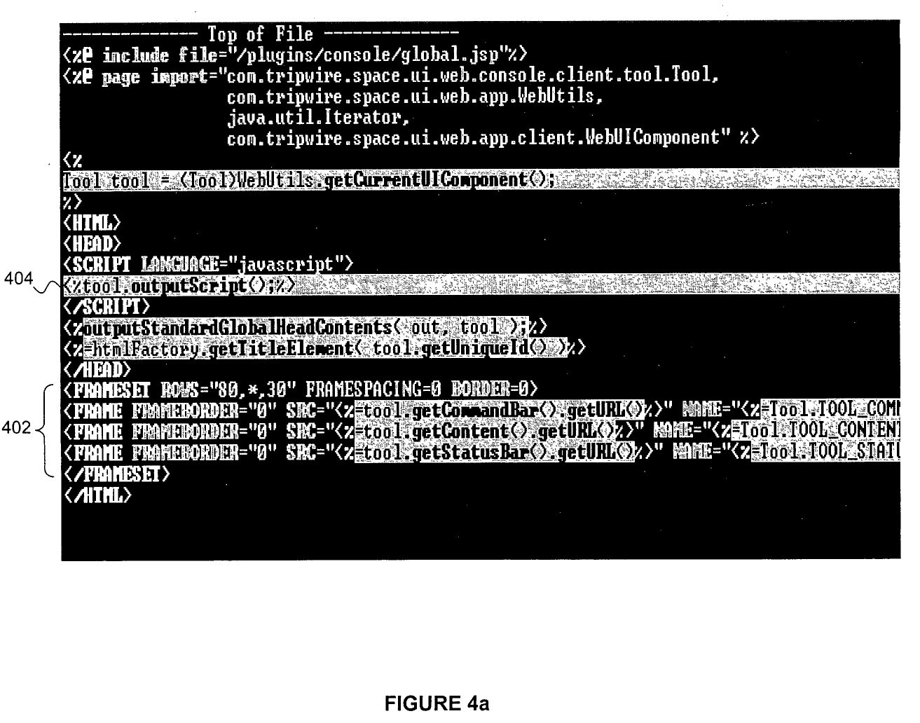

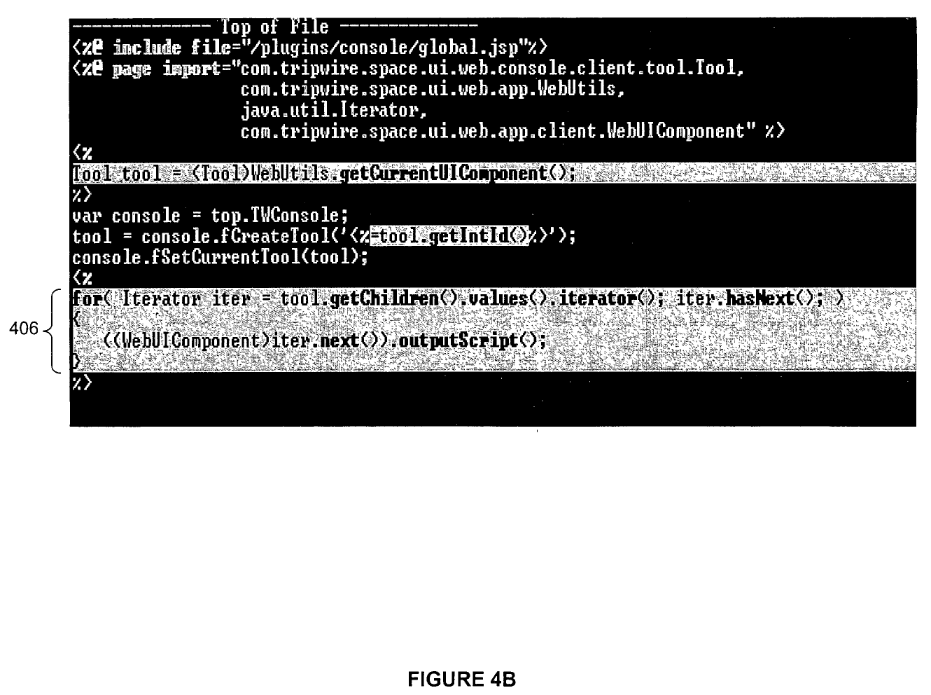

FIGS. 4a-b illustrate example Java Server Page code for obtaining and outputting a UI component and corresponding child components for display by a client. In FIG. 4a, example code used to define the “display” portion a particular tool is illustrated. As shown, children components of the requested tool are to be displayed in separate frames as indicated by the <FRAMESET> tag pair (402). Each child component is placed in an indicated frame within the frameset where a corresponding “getURL( )” method is called. The getURL( ) method returns the URL (i.e. Uniform Resource Locator) corresponding to the WebUI Component. If, however, the child component was contained within the same frame as the parent tool component, the outputDisplay( ) method (described above) could be invoked instead of the getURL( ) method. As described above, the “outputScript( )” method of the requested tool, located in the <HEAD> portion of the page (406), is called to output the tool's script.

In FIG. 4b, example script corresponding to the particular tool is illustrated. As shown, in accordance with one embodiment of the invention, the invocation of the tool's outputScript( ) method further causes the outputScript( ) method of all the tool's children to also be called (404).

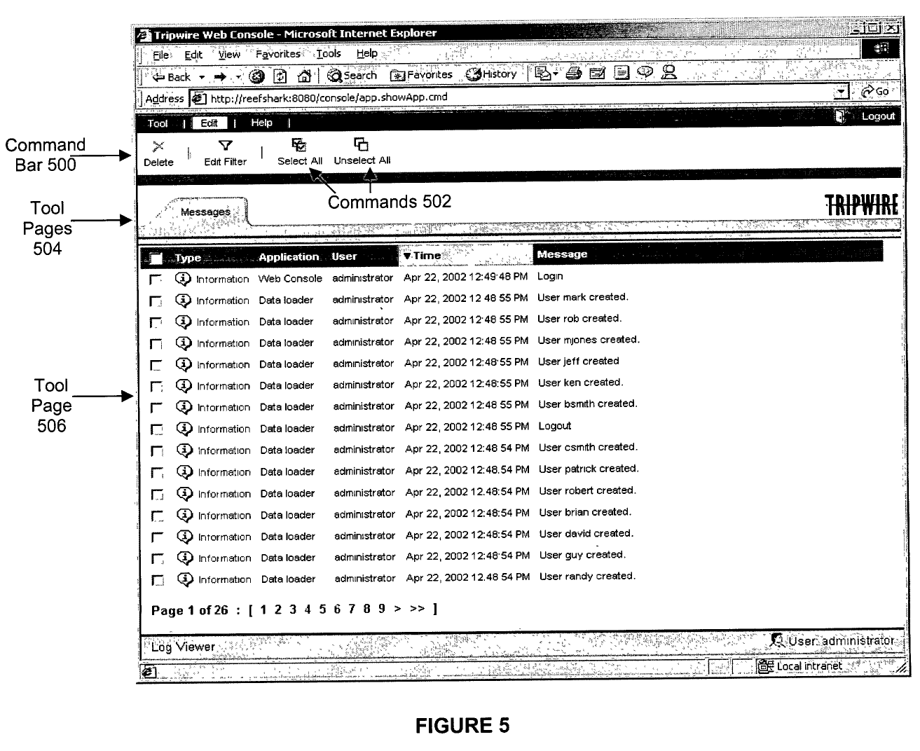

FIG. 5 illustrates an example graphical user interface showing the console UI component of FIG. 3 displayed in association with corresponding child components, in accordance with one embodiment. In the illustrated example, a “log viewer” tool component is shown, including command bar component 500 having commands 502, page tabs component 504, and tool page component 506. In one embodiment, each of the illustrated UI components (e.g. command bar, page tabs, tool pages) is displayed within a separate display frame. In one embodiment, a hidden frame is utilized to facilitate communication between the displaying client and the server.

Server Operational Flow

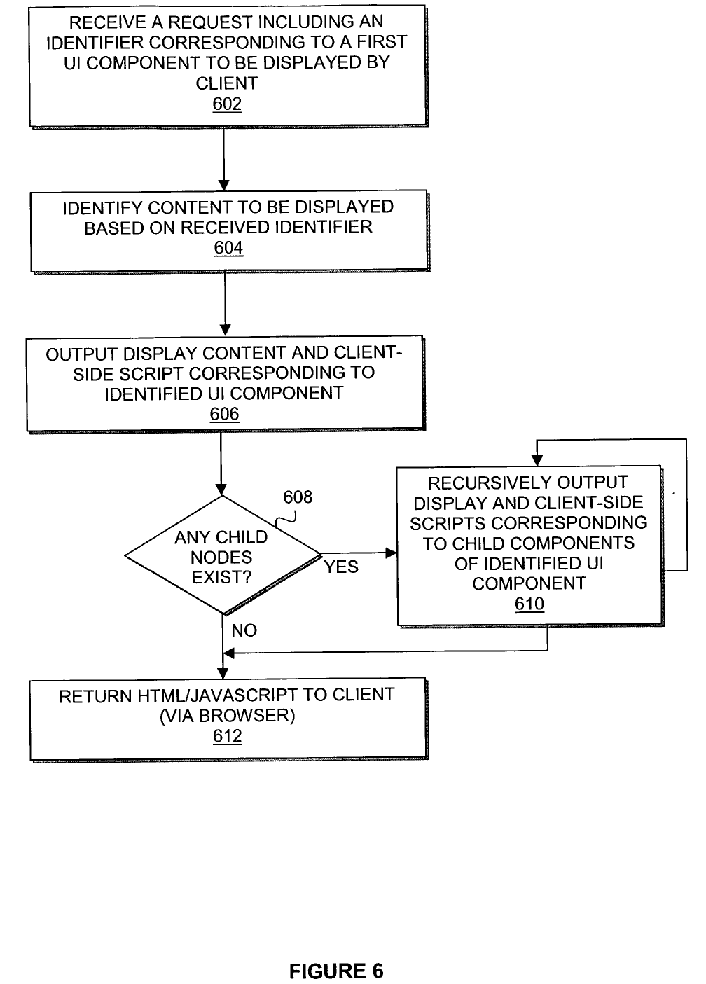

FIG. 6 illustrates an example operational flow for server 130, in accordance with one embodiment of the invention. As described above, the process begins with server 130 receiving a request from client 102 including an identifier corresponding to a first UI component to be displayed by client 102 (block 602). Next, server 130 identifies the content to be displayed based on the received identifier (block 604), and the display content and a client-side script corresponding to the identified UI component are output (block 606). At block 608, a determination is made as to whether the identified component contains any child components. If the identified component does not contain any child components, the resulting HTML/JavaScript is returned to the client (block 612). If, however, the identified component does contain one or more child components, then display content and client-side scripts corresponding to child components of identified UI component are recursively output (block 610), before returning the resulting HTML/JavaScript to the client (block 612).

Client-Side Architecture

In one embodiment, client 102 represents a general-purpose computing device such as a desktop/laptop/palmtop computer equipped with a JavaScript enabled web browser application such as Internet Explorer or Netscape Navigator. In accordance with the teachings of the present invention, a localized (i.e. distributed with respect to the server) object model is created on client 102 via the execution of one or more scripts (e.g. JavaScript based scripts) provided by server 130. In one embodiment of the invention, the localized object model comprises hierarchically associated UI objects including a command context and a window manager object to facilitate state sharing, and communication between components. As will be described in further detail below, such a unique arrangement assists in the provision of a distributed web based application endowed with an enhanced user experience.

Once the client has received the one or more scripts from the server, the client (e.g. via the browser application) executes the script(s). By so doing, a client-side object model corresponding to at least a portion of the server-side component model (e.g. server UI component architecture 238) is generated. In one embodiment, objects corresponding to only the one or more components of UI component architecture 238 accessed by the client, and each child component are generated from the script. As such, a large portion of the logic corresponding to a given tool is downloaded to and/or generated on (e.g. via the one or more scripts) the client the first time the tool is requested rather than components of a tool being downloaded dynamically as each component associated with the tool is to be displayed. Accordingly, with the generation of the client-side object model, in connection with the command context of the present invention (described below), subsequent communication between the client with the server (e.g. after execution of the tool script) can be decreased thereby decreasing the exposure to transmission delays and improving the user experience.

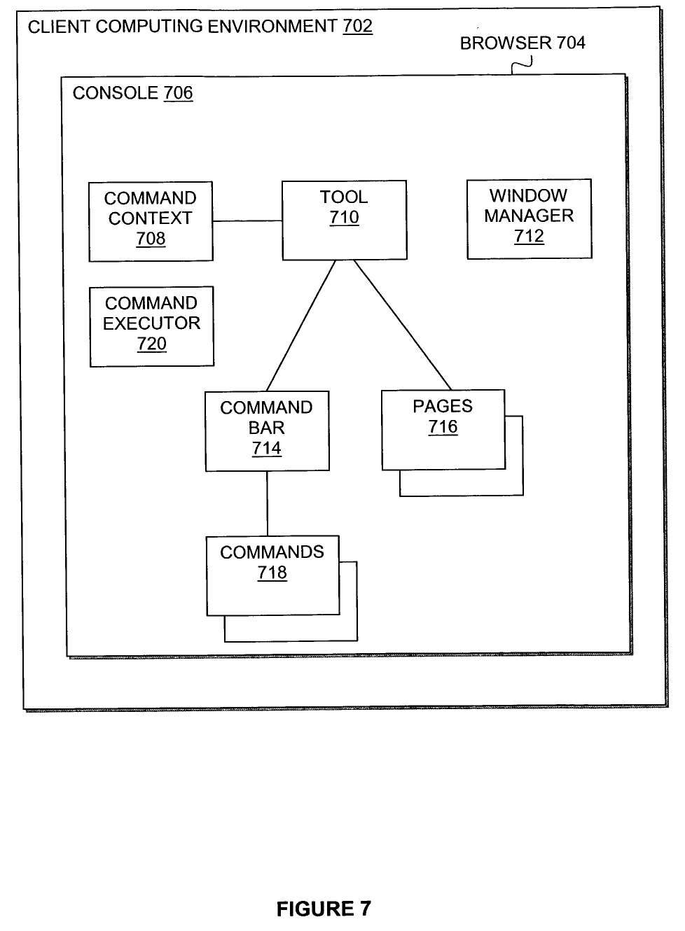

FIG. 7 illustrates an example client computing environment including a client-side object model generated in accordance with one embodiment of the invention. As shown, client computing environment 702 includes console 706 executing within browser 704. Console 706, in turn, includes current tool 710, which itself includes command bar 714, one or more commands 718, and one or more content pages 716, thus paralleling the component model shown in FIG. 3. Also included in console 706 is command context 708, window manager 712, and command executor 720.

Context Object

Command context 708 facilitates the sharing and communication of state information associated with one or more objects within computing environment 702. In the illustrated embodiment, command context 708 is associated with tool 710 to communicate state information between each of e.g. tool 710 and child objects 714, 716, and 718. Although command context 708 is shown to be associated with tool 710, command context 708 can nonetheless be associated with one more other/additional objects within console 706 and/or computing environment 704. As with the client-side object model, the command context is similarly hierarchical. Accordingly, in one embodiment if a particular object does not have a command context associated with it, the object inherits the command context from the parent object. For example, in the illustrated embodiment, each of content pages 716 may access command context 708 to obtain state information particularized for the requesting page.

In one embodiment of the invention, state information such as one or more parameters, parameter values, identifiers, and so forth are written to command context 708 after command execution or object invocation. Similarly, in response to invocation of an UI object such as tool 710, or child objects 714, 716, and 718, command context 708 is referenced to identify one or more parameters, parameter values, identifiers, and so forth, associated with invocation of that object. In accordance with one embodiment of the invention wherein command context 708 is implemented in an object-oriented manner, command context 708 includes a number of methods associated therewith. Such methods include but are not necessarily limited to those methods listed below in Table 1.

TABLE 1

| | |
|---|---|
| + setParameter() | + addObjectId() |
| + getParameter() | + hasObjectId() |
| + removeParameter() | + removeObjectId() |
| + addParameterValue() | + updateContext() |
| + removeParameterValue() | + updateForm() |
| + parameterValueExists() | + addChangeListener() |

The setParameter( ) and addParameterValue( ) methods, for example, facilitate the setting parameters and values within command context 708 that may be shared between components, and ultimately posted to the server. Likewise, the getParameter( ), removeParameter( ), and removeParameterValue( ) methods facilitate the retrieval and removal of parameters and values from command context 708. Furthermore, the addObjectId( ), hasObjectId( ) and removeObjectId( ) methods provide a means for assigning, identifying and removing object IDs to identify a calling object. Additionally, the updateContext( ) method operates to retrieve input values from a form and place the form's current state into command context 708, whereas the updateForm( ) method updates the form to reflect the current state of command context 708. Lastly, the addChangeListener( ) method enables components to register callbacks that will be invoked if a change occurs to command context 708. Accordingly, due at least in part on the provision of local command context, the conventional need to repeatedly communicate with the server can be reduced.

The above-enumerated methods may be implemented using any one of a number of techniques known in the art for implementing “set”, “get” and other related methods. They may be implemented in any number of programming languages such as C++, Java, and so forth. Such implementations are well within the ability of those ordinarily skilled in the art, and accordingly will not be discussed further.

Command Executor

Command executor 720 is responsible for executing a server command from commands 718 such as “DELETE”, “OK”, “IMPORT”,“UPLINK”, and so forth, and posting associated context data (e.g. such as items to be deleted) to the server for example. Such context data can, for example, originate from command context 708 or from standard HTML forms. In one embodiment, the HTTP based post is constructed dynamically using contents of command context 708, which are written out utilizing a hidden frame defined within a frame set. In one embodiment, the command executor encodes the invoking client command's location (e.g. via an unique identifier) for response callback by the server after the server processes the server command. Such a callback is returned to the command object that caused the server command to be executed, and can for example indicate whether the command resulted in a success or failure and any exceptions that occurred.

Window Manager

The window manager of the present invention facilitates centralized management of the presentation and display of secondary graphic window displays, such as dialogs and editors, associated with an executing web application. Through the use of window manager 712 for example, a web application can centrally limit what dialogs are open and control the disposition of the windows upon e.g. exiting the web application. In one embodiment, the window manager includes a mapping that associates a unique window identifier with each instantiated window object.

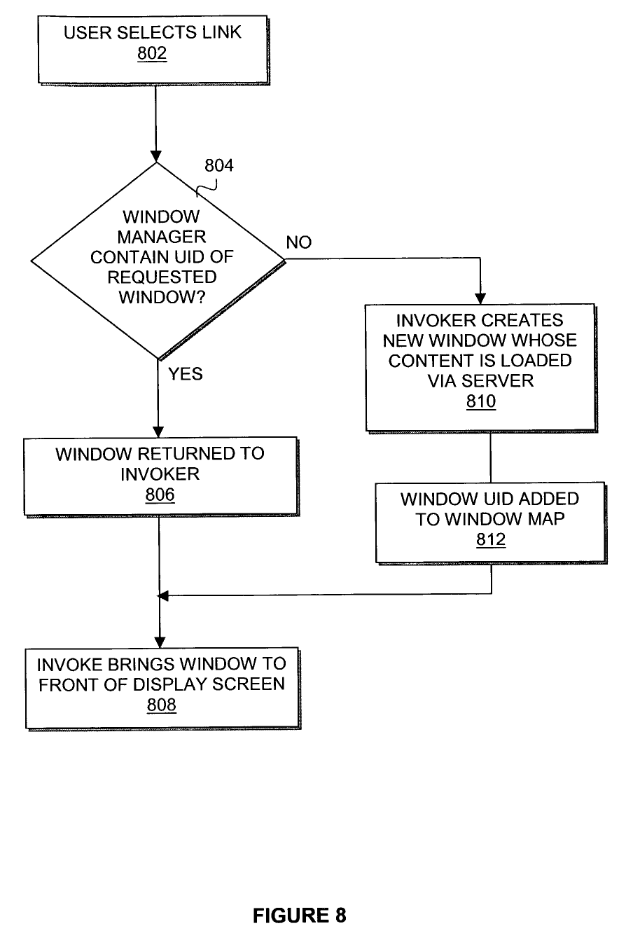

FIG. 8 illustrates an example operational flow of the window manager, in accordance with one embodiment of the invention. The process begins as a user selects e.g. a link displayed on the display screen (block 802). Next, the window manager determines if a unique identifier (UID) corresponding to the window being requested is stored within its window map (block 804). If the UID corresponding to the window being requested is present within the window map, the associated window is returned to the invoker (block 806), where it is then brought to the front of the display screen (block 808). However, if the UID corresponding to the window being requested is not present within the window map, the invoker creates a new window whose content is loaded from the server (block 810). The UID of the newly created window is then added to the window manager window map for future reference (block 812). Thus, due at least in part to the window manager of the present invention, each time the status of a command object is updated, a corresponding window can be automatically updated without the need to open another window or to change the status of the main browser window. Furthermore, the window manager facilitates in the closing of all secondary display windows upon the application closing (e.g. by the user logging out or navigating to another URL), thereby approximating the behavior of a non web-based application.

Example Operational Flow

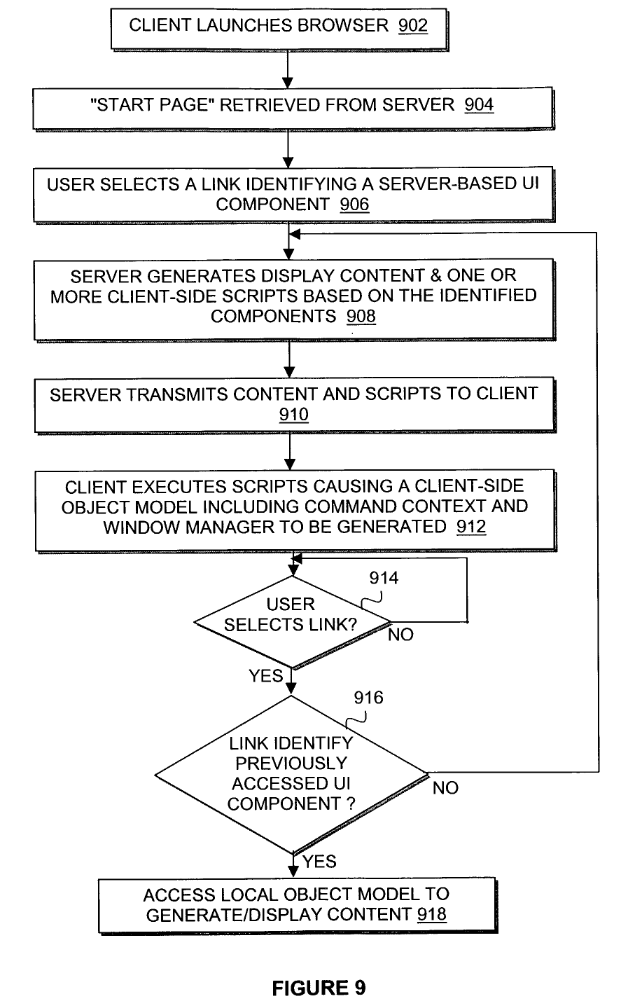

FIG. 9 illustrates a client-server operational flow in accordance with one embodiment of the invention as described herein. As alluded to above, in accordance with one embodiment of the invention, upon launching a browser application (block 902), a network connection is established between the client device and the server. In response, the server downloads a start page (block 904). Thereafter, when a user selects a link displayed within the start page identifying a server-based UI component, such as a tool, a command, property editor and so forth (block 906), the server is caused to generate display content and one or more client-side scripts based on the identified UI components (block 908). Once generated, the server transmits the scripts to the client (block 910), where they are executed so as to cause a client-side object model including a command context and window manager to be generated (block 912). Thereafter, when a user selects another link (block 914), a determination is made as to whether the selected link identifies a previously accessed UI component on the server (block 916). If the selected link does not identify a previously accessed UI component, the server generates display content & one or more additional client-side scripts based on the newly identified components (block 908). If, however, the selected link identifies a previously accessed UI component on the server, the local object model is accessed to facilitate generation and/or display of content (block 918). In accordance with the teachings of the present invention, prior to each request being transmitted to the server, the client may for example access the locally stored command context to retrieve state information. Similarly, in one embodiment, upon receiving a response from the server (e.g. via a hidden frame), the client accesses the window manager to determine whether a new window should be opened, based at least in part on the server response as determined e.g. by the calling command object.

Example Computer System

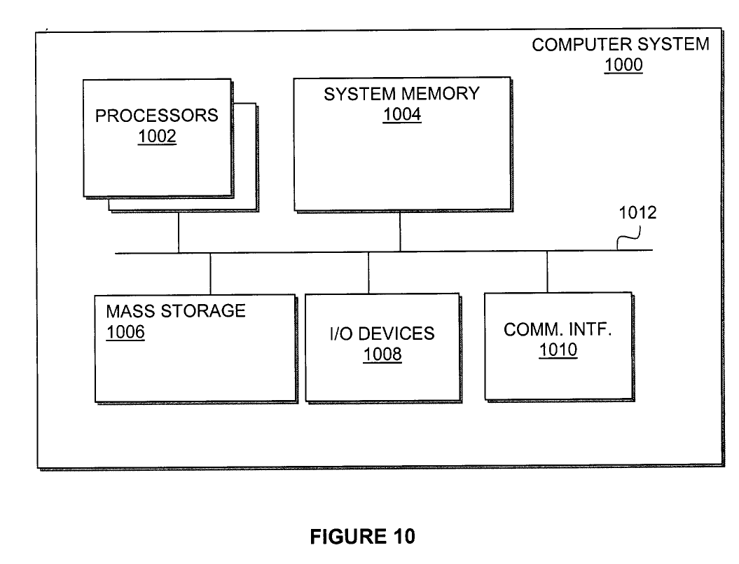

FIG. 10 illustrates a computer system suitable for use to practice the present invention, in accordance with one embodiment. As shown, computer system 1000 includes one or more processors 1002 and system memory 1004. Additionally, computer system 1000 includes mass storage devices 1006 (such as diskette, hard drive, CDROM and so forth), input/output devices 1008 (such as keyboard, cursor control and so forth) and communication interfaces 1010 (such as network interface cards, modems and so forth). The elements are coupled to each other via system bus 1012, which represents one or more buses. In the case of multiple buses, they are bridged by one or more bus bridges (not shown). Each of these elements performs its conventional functions known in the art. In particular, system memory 1004 and mass storage 1006 are employed to store a working copy and a permanent copy of the programming instructions implementing the execution engine, the expression processors, and so forth. The permanent copy of the programming instructions may be loaded into mass storage 1006 in the factory, or in the field, through a distribution medium (not shown) or through communication interface 1010 (from a distribution server (not shown)). The constitution of these elements 1002-1012 are known, and accordingly will not be further described.

Conclusion and Epilogue

Thus, it can be seen from the above descriptions, a method for provisioning distributed web applications has been described. While the present invention has been described in terms of the above-described embodiments, the present invention is not limited to the embodiments described. As the present invention can be practiced with further modification and alteration within the spirit and scope of the appended claims, the description is to be regarded as illustrative instead of restrictive on the present invention.

What is claimed is:

1. In a server, a method comprising:
receiving an identifier corresponding to a first user interface (UI) object to be displayed within a client browser;
generating one or more client-side scripts designed to facilitate generation of a hierarchical client based object model, the hierarchical object model including a root object, a context object to store state information corresponding to at least one of the root object and one or more child objects, and a window manager to facilitate control of one or more display properties of at least one secondary UI window;
generating display content associated with the first user interface object; and
transmitting the one or more client-side scripts, and content representing at least the first UI object.

2. The method of claim 1, wherein the first UI object comprises an outputDisplay method to facilitate generation of the display content, and an outputScript method to facilitate generation the one or more client-side scripts.

3. The method of claim 1, wherein the one or more client-side scripts are generated based upon meta-data stored within a corresponding hierarchically arranged server-side model containing a root node and one or more child nodes.

4. The method of claim 3, wherein each node of the hierarchically arranged server-side model is independently addressable.

5. The method of claim 4, wherein if a parent node of the hierarchically arranged server-side model is accessed, at least a subset of the one or more client side scripts are generated based upon meta-data corresponding to a parent node and each child node corresponding to the parent node.

6. The method of claim 5, wherein the first UI object comprises an outputDisplay method to facilitate generation of the display content, and an outputScript method to facilitate generation the one or more client-side scripts.

7. The method of claim 3, wherein the one or more client-side scripts are composed in JavaScript.

8. The method of claim 3, wherein a Java Server Page (JSP) generates the display content and transmits the display content to the client.

9. The method of claim 1, wherein the command context object comprises a plurality of methods including at least a set parameter method for setting values that may be shared between objects of the client based object model, and a get parameter method for retrieving the values that may be shared between the objects of the client based object model.

10. In a client browser, a method comprising:
receiving an user indication identifying a first user interface (UI) object to be displayed within the client browser;
transmitting an identifier corresponding to the first UI object;
receiving content representing at least the first UI object, and one or more client-side scripts designed to generate a hierarchical client based object model;
displaying the content representing at least the first UI object; and
generating the hierarchical object model on the client in response to execution of the one or more client-side scripts, the hierarchical object model including a root object, a context object to store state information corresponding to at least one of the root object and one or more child objects, and a window manager to facilitate control of one or more display properties of at least one secondary UI window.

11. The method of claim 10, wherein the identifier comprises a uniform resource locator (URL) associated with the first user interface object.

12. The method of claim 11, wherein the display content is generated based upon parameter data associated with the URL.

13. The method of claim 11, wherein the display content is displayed within a frame set including a hidden frame, the hidden frame to act as a command conduit for network based communication with a server.

14. The method of claim 10, wherein the hierarchical client based object model corresponds to a hierarchically arranged server-side model containing plurality of nodes including a root node and one or more child nodes.

15. The method of claim 14, wherein the identifier comprises a uniform resource locator (URL) associated with one of the plurality of nodes.

16. The method of claim 10, wherein the one or more client-side scripts are generated based upon meta-data stored within a corresponding hierarchically arranged server-side model.

17. The method of claim 10, wherein the window manager maintains a mapping between each secondary UI window object and a unique window identifier corresponding to each of the secondary UI window objects to facilitate a managed, multi-window display of content within the client browser.

18. The method of claim 17, wherein if an object makes a call to a secondary UI window object listed within the window manager mapping, the secondary UI window associated with the listed secondary UI window object is recalled.

19. The method of claim 10, wherein the context object comprises a plurality of methods including a setParameter method, a getParameter method, an updateContext method, an updateForm method, and an addChangeListener method.

20. The method of claim 19, wherein the setParameter method sets values to be shared between objects of the client based object model, and the getParameter method retrieves the shared values.

21. The method of claim 19, wherein the updateContext method stores current state information associated with a form and the updateForm method updates the form to reflect the state information stored within the context object.

22. The method of claim 19, wherein the addChangeListener method allows components to register callbacks to be invoked if a change occurs to the context object.

23. In a client browser, a method comprising:
receiving an user indication identifying a first user interface (UI) object to be displayed within the client browser;
transmitting an identifier corresponding to the first UI object;
receiving content representing at least the first UI object, and one or more client-side scripts designed to generate a hierarchical client based object model;
displaying the content representing at least the first UI object; and generating the hierarchical object model on the client in response to execution of the one or more client-side scripts, the hierarchical object model including a root object, and a command context to store state information corresponding to at least one of the root object and one or more child objects.

24. The method of claim 23, wherein the hierarchical object model further comprises:
a window manager to maintain a mapping between one or more secondary UI window objects and a unique window identifier corresponding to each of the secondary UI window objects to facilitate a managed, multi-window display of content within the client browser.

25. The method of claim 23, wherein the hierarchical client based object model corresponds to a hierarchically arranged server-side model containing plurality of nodes including a root node and one or more child nodes.

26. The method of claim 25, wherein the identifier comprises a uniform resource locator (URL) associated with one of the plurality of nodes.

27. An apparatus comprising:
a storage medium having programming instructions stored therein, which when executed operate to
receive an identifier corresponding to a first user interface (UI) object to be displayed within a client browser,
generate one or more client-side scripts designed to facilitate generation of a hierarchical client based object model, the hierarchical object model including a root object, a context object to store state information corresponding to at least one of the root object and one or more child objects, and a window manager to facilitate control of one or more display properties of at least one secondary UI window,
generate display content associated with the first user interface object, and
transmit the one or more client-side scripts, and content representing at least the first UI object; and
at least one processor coupled with the storage medium to execute the programming instructions.

28. The apparatus of claim 27, wherein the first UI object comprises an outputDisplay method to facilitate generation of the display content, and an outputScript method to facilitate generation the one or more client-side scripts.

29. The apparatus of claim 27, wherein the one or more client-side scripts are generated based upon meta-data stored within a corresponding hierarchically arranged server-side model containing a root node and one or more child nodes.

30. The apparatus of claim 29, wherein each node of the hierarchically arranged server-side model is independently addressable.

31. The apparatus of claim 30, wherein if a parent node of the hierarchically arranged server-side model is accessed, at least a subset of the one or more client side scripts are generated based upon meta-data corresponding to a parent node and each child node corresponding to the parent node.

32. The apparatus of claim 31, wherein the first UI object comprises an outputDisplay method to facilitate generation of the display content, and an outputScript method to facilitate generation the one or more client-side scripts.

33. The apparatus of claim 29, wherein the one or more client-side scripts are composed in JavaScript.

34. The apparatus of claim 29, wherein a Java Server Page (JSP) generates the display content and transmits the display content to the client.

35. The apparatus of claim 27, wherein the command context object comprises a plurality of methods including at least a set parameter method for setting values that may be shared between objects of the client based object model, and a get parameter method for retrieving the values that may be shared between the objects of the client based object model.

36. An apparatus comprising:
a storage medium having programming instructions stored therein, which when executed operate to
receive an user indication identifying a first user interface (UI) object to be displayed within the client browser,
transmit an identifier corresponding to the first UI object,
receive content representing at least the first UI object, and one or more client-side scripts designed to generate a hierarchical client based object model,
display the content representing at least the first UI object, and
generate the hierarchical object model on the client in response to execution of the one or more client-side scripts, the hierarchical object model including a root object, a context object to store state information corresponding to at least one of the root object and one or more child objects, and a window manager to facilitate control of one or more display properties of at least one secondary UI window; and
at least one processor coupled with the storage medium to execute the programming instructions.

37. The apparatus of claim 36, wherein the identifier comprises a uniform resource locator (URL) associated with the first user interface object.

38. The apparatus of claim 37, wherein the display content is generated based upon parameter data associated with the URL.

39. The apparatus of claim 37, wherein the display content is displayed within a frame set including a hidden frame, the hidden frame to act as a command conduit for network based communication with a server.

40. The apparatus of claim 36, wherein the hierarchical client based object model corresponds to a hierarchically arranged server-side model containing plurality of nodes including a root node and one or more child nodes.

41. The apparatus of claim 40, wherein the identifier comprises a uniform resource locator (URL) associated with one of the plurality of nodes.

42. The apparatus of claim 36, wherein the one or more client-side scripts are generated based upon meta-data stored within a corresponding hierarchically arranged server-side model.

43. The apparatus of claim 36, wherein the window manager maintains a mapping between each secondary UI window object and a unique window identifier corresponding to each of the secondary UI window objects to facilitate a managed, multi-window display of content within the client browser.

44. The apparatus of claim 43, wherein if an object makes a call to a secondary UI window object listed within the window manager mapping, the secondary UI window associated with the listed secondary UI window object is recalled.

45. The apparatus of claim 36, wherein the context object comprises a plurality of methods including a setParameter method, a getParameter method, an updateContext method, an updateForm method, and an addChangeListener method.

46. The apparatus of claim 45, wherein the setParameter method sets values to be shared between objects of the client based object model, and the getParameter method retrieves the shared values.

47. The apparatus of claim 45, wherein the updateContext method stores current state information associated with a form and the updateForm method updates the form to reflect the state information stored within the context object.

48. The apparatus of claim 45, wherein the addChangeListener method allows components to register callbacks to be invoked if a change occurs to the context object.
